(19) United States
(12) Patent Application Publication
(10) Pub. No.: US 2026/0023011 A1
(43) Pub. Date: Jan. 22, 2026

(54) METHOD AND APPARATUS FOR DETERMINING SURFACE WAVE DATA IN LIQUIDS

(71) Applicant: APOHA LIMITED, LONDON (GB)

(72) Inventor: SHAMIT SHRIVASTAVA, LONDON (GB)

(73) Assignee: APOHA LIMITED, LONDON, EN (GB)

(21) Appl. No.: 18/994,754

(22) PCT Filed: Jul. 19, 2023
(86) PCT No.: PCT/GB2023/051903

§ 371 Date: Jan. 15, 2025

(30) Foreign Application Priority Data
Jul. 19, 2022 (GB) 2210581.1

(51) Int. Cl. G01N 21/21; G01N 21/17; G01N 21/84

(52) U.S. Cl. CPC G01N 21/211; G01N 21/1717; G01N 21/8422; G01N 2021/1721; G01N 2021/1723; G01N 2021/213

(57) ABSTRACT

The present disclosure relates to methods and apparatus for characterising an interaction between a stimulus and a liquid thin film. An aspect of the disclosure provides a spectroscopic ellipsometry apparatus for characterising an interaction between a stimulus and a liquid thin film, the apparatus comprising: a stimulator, configured to provide a stimulus to a liquid thin film disposed on a volume of liquid to generate a wave in the liquid thin film, the liquid thin film and the volume of liquid having an interface therebetween, light beam optics for illuminating an area of the liquid thin film with a light beam, the light beam having a first polarisation, and a light collector coupled to a detector for receiving the light beam after reflection by the liquid thin film, the light beam having a second polarisation after reflection by the liquid thin film; a wave measurement module coupled to the light collector and configured to provide surface wave data to characterise a Lucassen wave in the liquid thin film based on the second polarisation.

### FIELD OF INVENTION

The present disclosure relates to methods and apparatus for characterising an interaction between a stimulus and a liquid thin film, and more particularly to methods and apparatus for characterising such interactions based on properties of surface waves in the liquid thin film, embodiments may employ spectroscopic ellipsometry methods for the observation of Lucassen waves.

### BACKGROUND

The surface of a material has a thermodynamic potential that is independent of its volume. The physical and chemical properties of a surface are derived from its thermodynamic potential. For example, the response of the surface to a mechanical perturbation is given by properties such as surface tension and lateral compressibility. Similarly, the response of the surface to an electromagnetic perturbation is given by properties such as surface dipole moment. As a result of these perturbation, different types surface waves may be generated on a surface e.g. a surface of a fluid (e.g. a liquid) forming an interface with another fluid (e.g.

air). Some example types of surface waves are: Rayleigh waves; Gravity waves; Capillary waves; Lucassen waves. The physics of these waves have been described in Nonlinear fractional waves at elastic interfaces Julian Kappler, Shamit Shrivastava, Matthias F. Schneider, and Roland R. Netz Phys. Rev. Fluids 2, 114804—Published 20 Nov. 2017. These waves may be hydrodynamically coupled.

Rayleigh waves are characterised by elliptical motion of a notional fluid particle in a plane which is perpendicular to the surface at equilibrium and parallel to the direction of propagation of the wave.

Gravity waves are characterised by a displacement from equilibrium of a notional fluid particle at the surface wherein the displacement of the notional particle is characterised by having a restoring force of gravity or buoyancy.

Capillary waves are characterised by a displacement from equilibrium of a notional fluid particle wherein the displacement of the notional fluid particle is in a direction transverse to the surface at equilibrium and transverse to the direction of propagation of the wave and have a restoring force of surface tension.

Lucassen waves are characterised by a displacement from equilibrium of a notional fluid particle at a surface of a wave-medium by oscillation in a direction parallel to that surface at equilibrium and parallel to the direction of propagation of the wave. In Lucassen waves this notional particle is subject to a restoring force resulting from the surface elastic modulus of the surface of the wave-medium. Put another way Lucassen waves are compression-rarefaction waves which occur in the plane of a boundary (an interface) between a wave-medium and an adjacent medium such as air.

Lucassen waves have been observed in lipid monolayers and in other types of liquid systems.

Shamit Shrivastava, Matthias F. Schneider Opto-Mechanical Coupling in Interfaces under Static and Propagative Conditions and Its Biological Implications describes how a wave can be generated in a lipid monolayer mechanically with a dipper and how parameters of the generated wave, such as the intensity of fluorescent particles therein and the lateral pressure of the surface wave, can be measured, for example using a photo detector and a Wilhemly balance respectively.

Shrivastava S, Schneider M F. 2014 Evidence for two-dimensionalsolitary sound waves in a lipid controlled interface and itsimplications for biological signalling. J. R. Soc. Interface 11: 20140098 describes a method in which Lucassen waves can be generated in a lipid monolayer and how parameters of said waves may be measured (e.g. fluorescence energy transfer (FRET) measurements; a piezo cantilever). The document also describes how the state of a lipid monolayer may be characterised by a variety of thin film parameters (e.g. surface density of lipid molecules, temperature, pH, lipid-type, ion or protein adsorption, solvent incorporation, etc.) and also how the state of the lipid monolayer can affect parameters of waves which propagate in the lipid monolayer.

Bernhard Fichtl, Shamit Shrivastava & Matthias F. Schneider, Protons at the speed of sound: Predicting specific biological signaling from physics Nature Scientific Reports describes how Lucassen waves can be generated in a lipid interface in response to a change in pH of the system and that the speed of these waves can be controlled by the compressibility of the interface. The document describes how parameters of these waves depend on the degree of change in pH. The document also describes how mechanical and electrical changes at the lipid interface can be measured (e.g. using a Kelvin probe).

Lucassen waves may be described as interfacial compression waves and may be considered two-dimensional sound waves (sound waves confined to a surface which forms a boundary between two phases e.g. a fluid-air boundary). In a manner analogous to sound waves, shock waves may exist in Lucassen wave systems (e.g. two-dimensional shock waves). Lucassen shock waves may be characterised in the same way as Lucassen waves with the additional constraint that the waves are characterised by changes in the wave medium which are nonlinear and/or discontinuous.

S. Shrivastava, Shock and detonation waves at an interface and the collision of action potentials, Progress in Biophysics and Molecular Biology, describes how Lucassen shock waves may propagate through a lipid interface.

WO2019234437A1 describes how a lipid interface may be used to transmit and receive signals. The document describes a signal processing device comprising: a first medium; a second medium; a lipid interface arranged between the first medium and the second medium, wherein the lipid interface comprises a plurality of lipid molecules; an input transducer arranged to apply an input signal to the lipid interface, wherein the input signal is arranged to generate a mechanical pulse in the lipid interface; and an output transducer arranged to receive an output signal by detecting a mechanical response in the lipid interface from the mechanical pulse generated in the lipid interface by the input transducer; wherein the lipid interface is arranged to propagate the mechanical pulse from the input transducer via the lipid interface to the output transducer.

### SUMMARY

Aspects of the invention are set out in the independent claims and optional features are set out in the dependent claims. Aspects of the disclosure may be provided in conjunction with each other and features of one aspect may be applied to other aspects.

An aspect of the invention provides a spectroscopic ellipsometry apparatus for characterising an interaction between a stimulus and a liquid thin film, the apparatus comprising:
a stimulator, configured to provide a stimulus to a liquid thin film disposed on a volume of liquid to generate a wave in the liquid thin film, the liquid thin film and the volume of liquid having an interface therebetween,
light beam optics for illuminating an area of the liquid thin film with a light beam, the light beam having a first polarisation, and a light collector coupled to a detector for receiving the light beam after reflection by the liquid thin film, the light beam having a second polarisation after reflection by the liquid thin film;
a wave measurement module coupled to the light collector and configured to determine surface wave data to characterise a wave in the liquid thin film based on the second polarisation.

The wave in the liquid film may comprise a plurality of wave modes, such as surface wave modes. For example, the plurality of wave modes may comprise at least one of Lucassen waves, capillary waves, gravity waves and Rayleigh waves.

The surface wave data may comprise sufficient degrees of freedom to provide an overdetermined representation of a surface wave in which one of the wave modes is a Lucassen wave. Other information may also be derived from the surface wave data. The surface wave data may comprise a waveform, e.g. a series of samples defining a time varying signal comprising features such as amplitude, time of arrival, frequency and phase etc. The contributions to these aspects of the measured signal may comprise contributions from the different wave modes present, including Lucassen waves. This can enable a feature vector to be extracted from the surface wave data to define features such as those of Lucassen waves. Features explicitly defining these or other wave modes need not actually be extracted provided that the underlying physical measurement is sensitive to such effects so they are present and determinable from the data (sufficiently specified by the data). The apparatus and methods of the present disclosure, by their use of ellipsometric techniques, may enable Lucassen wave mode information/effects to be present and determinable in the surface wave data.

The surface wave data may be based on: an s-polarisation component of the second polarisation and on a p-polarisation component of the second polarisation. For example it may comprise an indication of the SP ratio.

The surface wave data may indicate a change in the state of polarisation from the first polarisation to the second polarisation. This may indicate how the direction of polarization is changed by reflection by the liquid thin film and/or how the distribution of polarisation has changed by that reflection.

The surface wave data may comprise a first time series of samples collected from the liquid thin film, and the wave measurement module may be configured to provide, based on the first time series, a second time series wherein the second time series has a lower sample rate than the first time series. The second time series may have a sample rate of at least 20 kHz, for example at least 10 kHz.

The sample rate of the second time series may be selected based on the size of the area.

The light beam may comprise a beam of coherent light, such as a laser. The laser may have a direction of polarisation, and the light beam optics may be configured to rotate the direction of polarisation so that it is aligned with the p-polarisation axis at the thin film, e.g., at its surface.

The light beam optics may be configured to focus the beam of light, for example to provide a focal point of the beam which is positioned so that the beam is non-collimated (e.g., diverging or converging) when it meets the light collector.

The liquid thin film may comprise at least one of a protein and a lipid. The light beam may comprise wavelengths selected according to a component of the thin film. The light beam may be provided to the surface at an angle of incidence selected according to a component of the thin film.

The stimulator may comprise a test substance provider configured to contact the surface of the liquid with a test substance thereby to provide the stimulus.

The stimulator may be configured to provide an electrical stimulus to the thin film.

Operation of the light collector may be coupled to operation of the stimulator such that surface wave data can be determined at selected times after the stimulus, for example the said times may be selected based on a location of the stimulus on the surface.

The stimulus may generate a plurality of wave modes, such as surface wave modes, in the liquid thin film. For example, the plurality of wave modes may comprise, in addition to Lucassen waves, at least one of capillary waves, gravity waves and Rayleigh waves.

An aspect of the invention provides a method comprising:
providing a stimulus to a liquid thin film disposed on a volume of liquid to generate a wave in the liquid thin film, the liquid thin film and the volume of liquid having an interface therebetween, illuminating an area of the liquid thin film with a light beam, the light beam having a first polarisation, and
receiving the light beam after reflection by the liquid thin film, the light beam having a second polarisation after reflection by the liquid thin film;
determining, based on the received light beam, surface wave data to characterise a Lucassen wave in the liquid thin film based on the second polarisation.

The surface wave data may be based on: an s-polarisation component of the second polarisation and on a p-polarisation component of the second polarisation. For example it may comprise an indication of the SP ratio of the light beam after reflection by the liquid thin film.

The size of the area may be defined by the beam size at the liquid thin film, and may have a radius of less than 5 mm, for example less than 1 mm.

The method may comprise focusing the beam of light to provide the beam size and/or so that the beam is non-collimated (e.g. converging or diverging) when it meets the light collector.

In the presence of viscoelastic thin films on the surface of a liquid, multiple surface wave modes governed by different physics and timescales can co-exist and co-propagate. Embodiments of the disclosure may address the problem of how to resolve the information contained in such waves.

Some embodiments use the interaction of polarized light incident on a liquid thin film at multiple angles and/or multiple wavelengths. This may provide an overdetermined system to allow wave modes which otherwise may be difficult or impossible to characterise to be completely specified. The use of multiple angles and/or multiple wavelengths may enable information existing in the dynamic surface modes to be obtained more rapidly (e.g., in parallel from measurement of a single interaction point between thin-film and illumination).

Any feature of any one of the examples disclosed herein may be combined with any selected features of any of the other examples described herein. For example, features of methods may be implemented in suitably configured hardware, and the configuration of the specific hardware described herein may be employed in methods implemented using other hardware.

### BRIEF DESCRIPTION OF THE DRAWINGS

Embodiments of the disclosure will now be described, by way of example only, with reference to the accompanying drawings, in which:

FIG. 1 is a functional block diagram of an apparatus according to the present disclosure;

FIG. 2 is a flowchart depicting a method of operating an apparatus such as that described with reference to FIG. 1; and

FIG. 3 is a functional block diagram of an apparatus such as that illustrated in FIG. 1

FIG. 4A is a schematic view of a reservoir computing unit;

FIG. 4B is a simplified top-down schematic view of a reservoir computing unit having two inputs;

FIG. 5 is a schematic view of a first reservoir computing unit coupled to a second reservoir computing unit;

FIG. 6 is a schematic view of a network of reservoir computing units.

In the drawings like reference numerals indicate like elements.

### SPECIFIC DESCRIPTION

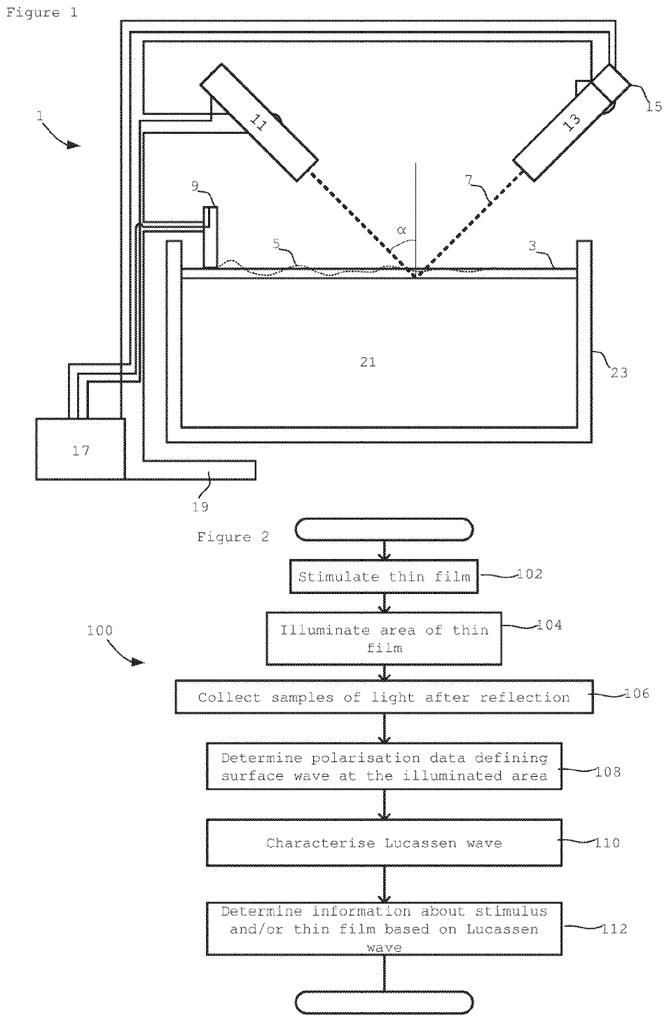

FIG. 1 shows a spectroscopic ellipsometry apparatus 1 for characterising an interaction between a stimulus and a liquid thin film 3. The apparatus characterises a Lucassen wave 5 in the liquid thin film 3 based on the polarisation of a reflected light beam 7, in particular it may use a ratio between the s-polarisation component and the p-polarisation component of the reflected light beam 7 to sense variations in refractive index (and hence density) of the liquid thin film 3. A time series of such data can be used to characterise Lucassen waves 5 without the need for labels such as those used in so called “Förster” or fluorescence resonance energy transfer (FRET) techniques.

The apparatus 1 shown in FIG. 1 comprises, a stimulator 9, light beam optics 11, a light collector 13, a detector 15, and a wave measurement module 17. As illustrated in FIG. 1, the apparatus 1 also comprises a reservoir 23 holding a volume of liquid 21 and having the liquid thin film 3 at the surface of the volume of liquid 21. The reservoir 23 may be provided by a trough, such as a Langmuir trough.

Also shown in FIG. 1 are mechanical fixtures 19 for holding the apparatus in position with respect to the reservoir 23, but it will be appreciated that these fixtures 19 are not essential and may be made and sold separately from the apparatus 1 itself. The wave measurement module 17 is connected to the stimulator 9 and to the detector 15 for the communication of control signals and data, it may also be connected to the light beam optics 11.

Typically, the thin film 3 comprises a type of liquid which is different from that of the volume of liquid 21. The liquid thin film 3 and the volume of liquid 21 may therefore have an interface between them such as a liquid-liquid interface. The thin film 3 may have viscoelastic properties. These and other types of thin films may exhibit a variety of surface wave modes in response to stimulus. Examples of such wave modes comprise Rayleigh waves, gravity waves, capillary waves and Lucassen waves.

Examples of types of liquid which provide the thin film 3 include proteins and lipids and other types of liquid. It will be appreciated in the context of the present disclosure that such materials may also be held (e.g., dispersed in suspension or otherwise) in the volume of liquid and dynamic equilibrium may exist between the thin film and the material held in the volume of liquid 21. Examples of types of liquid which may provide the volume of liquid 21 comprise aqueous solutions.

The light beam optics 11 comprise a source of polarised light arranged to illuminate an area of the liquid thin film 3 with a beam 7 having a selected angle of incidence a. The light beam 7 may also be coherent. Examples of suitable light sources include lasers and the light beam optics may comprise a polariser.

The light collector 13 is arranged to receive the beam of light 7 after reflection by the area of the thin film and to provide the reflected beam of light to the detector. The light collector 13 is positioned so that the optical axis of the light collector 13 is directed to the area of the thin film 3 at the angle of specular reflection, α, of the light beam incident on the thin film from the light beam optics.

The detector 15 is configured to sense parameters of the light received from the light collector 13 and to provide signals to the wave measurement module 17 including those parameters. Typically, those parameters comprise the polarisation of the light beam 7. For example the parameters may comprise a measure of the intensity of one or more polarisation components of the received light, such as the intensity of (a) an first component of the second polarisation and/or (b) a second component of the second polarisation. The second component may be orthogonal to the first component. The first component may be the s-component and the second component may be the p-component.

The stimulator 9 is positioned with respect to the thin film 3 so that it can apply a stimulus to the thin film 3. For example, the stimulator 9 may comprise a source of a test substance and may be configured to contact the surface of the thin film 3 with the test substance to provide the stimulus. Such stimulus may create a wave 5 in the liquid thin film 3 exhibiting some or all of the above wave modes.

The wave measurement module 17 is configured to control the stimulator 9 to apply the stimulus to the thin film 3, and to operate the detector 15 to collect a time series of samples of the light received at the detector 15. These samples may comprise samples of the intensity of the one or more polarisation components mentioned above. Typically the sample rate is at least 1 MHz, for example 10 MHz. The wave measurement module may also be configured to apply a low pass filter to the time series before down-sampling the data to 20 kHz or thereabouts. Typically, the sample rate of the down-sampled time series is selected based on the size of the illuminated area and the expected speed of the wave in the thin film. For example, the expected speed may be approximately 1 ms⁻¹ and the illuminated area may have a diameter of ˜5 mm, in which case the upper limit on the frequency of surface waves that can be meaningfully sampled will be 10 kHz. The sample rate of the down-sampled time series may be selected to ensure that the measurement remains well within this available bandwidth.

The wave measurement module 17 may be configured to control the timing of these samples based on the operation of the stimulator 9, for example so that the surface wave 5 in the area of the thin film illuminated by the beam 7 can be sampled at a selected time after the stimulus and for a selected duration. The time and/or duration typically are selected based on the distance from the part of the thin film 3 to which the stimulus is applied to the illuminated area. The wave measurement module may be further configured to provide a particular sampling scheme for a particular measurement type. The wave measurement module may be configured to implement a first sampling scheme to perform a first measurement type and to implement a second, different, sampling scheme to perform a second, different, measurement type. For example, to measure viscosity or hydrophobicity in a lipid thin film, or to measure binding in a protein thin film, the wave measurement module may use a long sampling duration (total time for which samples are collected). Recording of a single stimulus typically has a time resolution of microsecond and duration of seconds. This can be sufficient for measurement of properties of molecule that interact strongly with the film and/or are fast, for example electrostatic interaction or hydrogen bonding. In some embodiments multiple such stimulations with a repetition rate of few seconds observed over a course of minutes to hours could provide improved measurement of properties of molecules that interact weakly and/or slowly with the film, for example binding or reaction kinetics.

In other modes, the wave measurement module may be configured to sample data in a selected time interval following the application of a stimulus to the thin film, and to repeat the same sampling in that same time interval after subsequent stimuli to provide repeated measurements. Such measurements may be of relatively short duration.

In operation, the wave measurement module 17 operates the stimulator 9 to apply a stimulus to the thin film 3. This triggers a surface wave 5 in the thin film 3. The wave travels outwardly, across the thin film from the location at which the stimulus is applied. The light beam optics 11 illuminate an area of the thin film, and the wave measurement module 17 operates the detector 15 to take a series of samples of the light beam 7 reflected by the area and provided by the light collector 13 to the detector 15.

Accordingly, the disturbance of the thin film 3 at the location as a function of time can be recorded in a series of samples of data (a time series). Each sample in that time series may comprise polarisation data, which may be in the form of the intensity of the s-polarisation component and the intensity of the p-polarisation component of the reflected light. The wave measurement module 17 may be configured to determine an indication of the polarisation angle of the reflected beam 7, such as a ratio of the intensity of the s-component to the intensity of the p-component for each sample. The wave measurement module may derive features of the Lucassen wave from this time series. Examples of features of the Lucassen wave include its amplitude, frequency content, phase velocity, group velocity, phase and so forth. The wave measurement module 17 may then use these features of the Lucassen wave to provide information about the stimulus or about the thin film as described below.

It will be appreciated in the context of the present disclosure that the change in polarisation caused by reflection by a thin film is related to the refractive index of that film. The inventors in the present case have appreciated that in a thin film refractive index is also related to the density of the thin film. Accordingly, the wave measurement module can derive, from the time series of samples, such as the s-p ratio, information about variations in the density of the thin film as a function of time. This may enable Lucassen waves to be characterised without the need for labels such as those used in FRET methods.

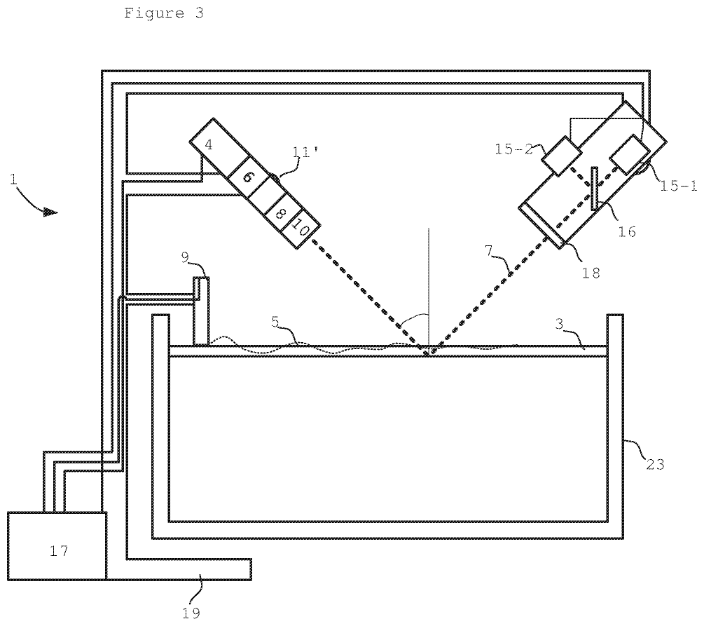

FIG. 2 illustrates a method 100 of operating apparatus, such as that shown in FIG. 1, to characterise a Lucassen wave in a liquid thin film. Such methods may also be used to characterise the stimulus as described below.

The method illustrated in FIG. 2 comprises providing a stimulus to a liquid thin film 3 disposed on a volume of liquid 21 to generate a wave 5 in the liquid thin film 3. The stimulus may be a chemical stimulus, such as may be achieved by applying a droplet of a test substance to the thin film 3.

The stimulus causes a wave 5 in the thin film, which propagates across the thin film 3 until it reaches the area of the liquid thin film which is illuminated 104 with a light beam 7.

Typically, the light beam 7 has a defined polarisation prior to reflection by the thin film 3. The beam may be focussed so that a focal point of the beam 7 lies between the light source and the thin film or between the thin film and the detector. In these embodiments the light beam which strikes the thin film is noncollimated (e.g., diverging or converging) and this may provide a range of angles of incidence across the area. This may assist in reducing fluctuations in signal intensity associated with distortion (vertical displacement) of the thin film by the wave and/or undesirable interference effects in the light collector optics.

Samples of the light reflected from the illuminated area are collected 106 and the polarisation of the reflected light 7 is determined 108 from these samples. This may be done with reference to the change from the original polarisation of the light beam 7 (e.g., prior to reflection by the thin film 3). One way to do this is to polarise the light beam (e.g., using a polariser interposed between the light source and the thin film). The changes in polarisation may be determined based on intensity of an s-polarisation component of the reflected light beam and on intensity of a p-polarisation component of the second polarisation. For example, the s-p ratio may be used. Accordingly, the change in polarisation of the beam caused by reflection by the thin film can be determined for each sample in the time series. The time series may be filtered and downsampled as described above. This provides a method of characterising 110 the Lucassen wave in the liquid thin film 3 by using the time series of changes in polarisation measured by this light beam.

The wave measurement module 17 or other processing means may thus determine 112 features of the Lucassen wave from this data including its amplitude, frequency content, phase velocity, group velocity, phase and so forth.

This has a number of technical uses.

As a first example it may provide a method of characterising the stimulus. To do this the wave measurement module or other processing means may compare the features of the Lucassen wave resulting from the stimulus to be characterised with the same features obtained from Lucassen waves resulting from other stimuli, such as a known or reference stimulus. The stimulus in question may be a chemical stimulus, which may be provided by contacting the thin film with a test substance, such as a droplet comprising the test substance. Features of the Lucassen wave resulting from that stimulus of a known thin film may be compared to those resulting from a known chemical stimulus of that same thin film, such as stimulus with a known or reference substance. This may be used to indicate the presence or absence of a substance of interest in the test substance and/or it may provide a method of characterising the test substance itself.

As a second example, this may provide a method of characterising a material in the thin film. To do this the wave measurement module or other processing means may compare (a) the features of the Lucassen wave obtained from the response of the thin film comprising the material to a known stimulus with (b) the features of the Lucassen wave obtained from the response of a reference thin film (e.g., a thin film without that material or some other reference film). In this example the stimulus may be provided by a chemical stimulus such as a droplet of a known material, or it may be provided by an electrical stimulus, for example in the form of a test signal such as a voltage pulse of a known form. In this example, features of the Lucassen wave resulting from that stimulus of a thin film having particular constituents (e.g., a lipid or protein thin film with a test substance) may be compared to those features in a Lucassen wave evoked by the same stimulus in a different thin film, such as a thin film having at least one different constituent (e.g., the same lipid or protein without the test substance or with a different dopant). This may provide a method of characterising the test substance and/or for detecting the presence of a test substance in a lipid and/or for determining a similarity measure between test substances.

The comparisons described above may be performed by any appropriate method. For example, the wave measurement module or other processing means may be configured to provide a vector of data comprising the features of the first Lucassen wave and to determine a “distance” in the vector space defined by that vector of features from the vector for the first Lucassen wave to the vector for the second Lucassen wave. This distance may be a Euclidean distance.

It will be appreciated by the skilled addressee in the context of the present disclosure that the methods and apparatus explained with reference to FIG. 1 and FIG. 2 may be implemented in a variety of different ways. One possible implementation is illustrated in FIG. 3.

FIG. 3 shows a spectroscopic ellipsometry apparatus 1′ which is identical to the described with reference to FIG. 1, but in which the light beam optics 11 and the light collector 13 and detector 15 are implemented in a particular way.

In the embodiment illustrated in FIG. 3, the light beam optics 11′ comprises an optical train comprising, in the following sequence: a laser 4 which provides a source of coherent light, an optical lens module 6 for conditioning the beam profile, a wave plate 8, and a linear polariser 10.

Typically the optical lens module 6 comprises one or more beam conditioning elements such as lenses which are configured to modify the profile of a laser beam passed through the module. The optical lens module 6 of the embodiment illustrated in FIG. 3 is arranged to provide a Gaussian beam profile, but other profiles may be used. The optical lens module 6 may comprise focussing elements, such as lenses, arranged so that a beam passed through the module 6 converges on a focal point positioned before the beam meets the thin film.

Typically, the laser beam has a natural polarisation in a particular direction—generally the ratio of the polarisation components is 1000:1 or thereabouts. The wave plate 8 is a half-wave plate, configured to phase shift one polarisation component of the laser light with respect to its orthogonal component by π (180°). This may rotate the polarisation of the light from the laser so that the laser's dominant polarisation component is aligned with the P-polarization axis at the surface of the volume of liquid in the reservoir 23. The beam, conditioned by the wave plate, is then provided to the linear polariser 10 which blocks passage of light which is not polarised in alignment with the polariser. The use of a waveplate 8 in sequence with a linear polariser 10 may serve to provide linear polarisation without undue attenuation.

As shown in FIG. 3, the optical train in the light collector comprises a laser line filter 18 followed by a polarising beam splitter 16 which is followed in turn by two separate intensity detector elements 15-1, 15-2. The first of these 15-1 is behind the polarising beam splitter 16 for receiving light transmitted through the beam splitter 16 and the other 15-2 is positioned for receiving light reflected by the beam splitter 16.

The laser line filter 18 may reduce the intensity of ambient light which is admitted to the light collector optics to increase SNR.

The first detector element 15-1 and the second detector element 15-2 each comprise a light intensity detector connected to the wave measurement module 17 for providing respective light intensity signals to it indicating the intensity of light incident upon each corresponding detector element 15-1, 15-2.

In operation of this apparatus the laser 4 produces a beam of light 7 and the optical lens module 6 conditions the beam 7 so that the profile is Gaussian. The lens module 6 also focuses the beam 7 so that it is not collimated and to provide a selected beam diameter at the thin film 3. For example, the lens module 6 may be configured so that the beam diameter at the point of incidence on the thin film may be less than 5 mm, for example less than 2 mm.

The beam 7 traverses the wave plate 8 which retards one polarisation component of the beam 7 by π (180°) to align the direction of polarisation of the beam with the P-polarisation axis at the thin film. The beam 7 is then provided from the wave plate 8 to the linear polariser 10 which blocks light which is not aligned with the polarisation direction of the polariser. The polarised beam transmitted through the polariser 10 is then incident on the thin film 3. The light beam optics may be arranged so that the angle of incidence α of the beam 7 on the thin film 3 comprises the Brewster angle. Because the light beam optics can be configured to provide a non-collimated beam, the beam 7 may be converging or diverging when it meets the thin film. As a result, a range of angles of incidence may be provided within the one beam. This may have particular advantages for the imaging of waves in/on a liquid thin film.

The light beam 7 is then reflected by the thin film to the light beam collector. Reflection of the light beam by the thin film causes a change in the polarisation of the light beam. The size of this change depends on, amongst other factors, the refractive index of the thin film. This in turn depends on the density of the thin film. It will therefore be appreciated that the polarisation of the reflected light beam may differ from that of the incident light beam.

The reflected light beam, with its polarisation modified by reflection, then passes through the laser line filter of the light collector to reach the beam splitter 16. The beam splitter 16 reflects the polarization component of the light beam which is orthogonal to its polarisation axis on to a first one of the detector elements. The component which is parallel to its polarisation axis is transmitted through to the second one of the detector elements.

The detector elements 15-1,15-2 each provide a signal indicating the incident light intensity to the wave measurement module 17.

The wave measurement module 17 then samples the intensity signals from the two detector elements at a first sample rate (e.g. 1 MHz or more) to provide a first time series. The wave measurement module applies a low pass filter to this time series, and then down-samples the filtered time series to provide a second time series having a second sample rate. The cut off frequency of the low pass filter may be selected according to the Nyquist criterion of the second sample rate (e.g., so that the second sample rate is at least twice the cut off frequency of the low pass filter). The signals from the first detector element and/or the second detector element can then be used to provide an indication of the polarisation angle of the reflected light beam. This can be used to determine, (e.g., with reference to the polarisation of the beam provided by the light beam optics) the extent to which the polarisation has been rotated by reflection by the thin film. For example, the ratio of the two polarisation components may be used to provide an indication of the polarisation angle of the reflected beam.

Thus, any wave caused by applied stimulus propagates via the thin film 3 to the area illuminated by the laser beam 7. Variations in density in the thin film at the area can then be detected by the wave measurement module as variations in the polarisation angle of the reflected beam, which can be observed in the (optionally filtered and down-sampled) time series of samples obtained from the illuminated area. This data provides an indication of time varying disturbances in the density of the thin film, thereby enabling Lucassen waves to be observed. This can enable parameters of the Lucassen waves such as their phase, amplitude, frequency content, phase velocity, group velocity and so forth. Embodiments permit measurement of how the polarization vector has changed upon reflection, e.g., how the direction of polarization has changed and also how the distribution of polarization has changed for example the extent to which a highly polarised beam becomes less polarised after interaction.

Further embodiments are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the disclosure.

For example, the measure of the change in polarisation angle may be determined without the need to measure both components by measuring the change in one of the components caused by reflection and providing some adjustment to account for attenuation of the beam. The signal may be filtered and down sampled before determining the polarisation angle of the reflected beam, of the polarisation angle may be determined first. In some embodiments the two polarisation signals may be combined in the analogue domain prior to digitisation.

The laser line filter described with reference to FIG. 3 may be provided by any appropriate optical filter, such as a band pass filter. The pass band of such a filter may be selected based on the wavelength of the light source used in the light beam optics. In some embodiments a band stop filter may be used instead having a stop band selected to attenuate the most prevalent ambient light sources.

A wave plate has been described as an option in the apparatus of FIG. 3 but other means of altering the polarization state of the light may be used—for example, any method of retarding (or delaying) one component of polarization with respect to its orthogonal component. One alternative to conventional crystalline quartz waveplates is a polymer retarder film. The means of altering the polarization state of the light may be achromatic.

It will be appreciated that the light collector of the apparatus shown in FIG. 3 may be used in the apparatus of FIG. 1 and vice versa.

The physical system described herein can be used for reservoir computing. For example, if an input signal is used to provide the stimulus and an output signal is derived from the surface wave data it can be seen that the spectroscopic ellipsometry apparatus of the present disclosure provides a data operation which transforms this input signal into this output signal.

Equally, a reservoir computing unit may be used to apply a transformation to an input signal thereby to generate an output signal. The relationship between the output signal and the input signal corresponds to a transformation applied to the input signal by the reservoir computing unit. Embodiments of the disclosure therefore provide a reservoir computing unit comprising a spectroscopic ellipsometry apparatus of the present disclosure in which the stimulator provides the stimulus based on the input signal (e.g. a stimulus which encodes information carried by the input signal). The reservoir computing unit provides an output signal based on the wave data arising from this stimulus. Two or more of these reservoir computing units can be connected together to form a network each of which may perform a different data operation. In some embodiments the stimulator may be configured to apply stimuli corresponding to two or more input signals. These may be applied to the liquid separately from each other so that the corresponding wave data encodes information corresponding to the combination of those two signals.

It can thus be seen that in such units the output signal may depend on the input signal (or signals) in a non-linear way. A function associated with transforming the input signal (or signals) to the output signal may correspond to or represent a data operation performed by that reservoir computing unit.

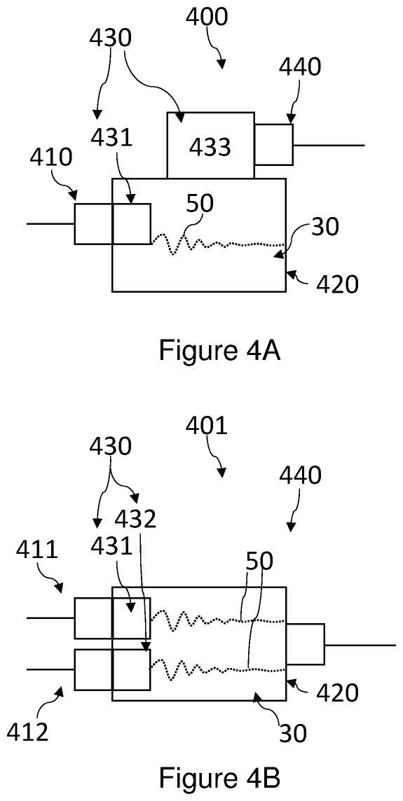

FIG. 4A is a schematic view of an example reservoir computing unit 400. The reservoir computing unit comprises: an input 410; a reservoir 420 for holding a liquid 30; a spectroscopic ellipsometry apparatus 430; and, an output 440.

As described elsewhere herein, the spectroscopic ellipsometry apparatus 430 comprises: a stimulator 431, configured to provide a stimulus to the liquid 30 to generate a response (e.g. a wave at the surface of the liquid); light beam optics (not shown in FIG. 4A) for illuminating an area of the liquid 30 with a light beam, the light beam having a first polarisation; and a light collector (not shown in FIG. 4A) coupled to a detector for receiving the light beam after reflection by the surface, the light beam having a second polarisation after reflection by the wave; a wave measurement module (not shown in FIG. 4A) coupled to the light collector and configured to provide surface wave data based on the second polarisation; an output 440 for providing an output signal based on the surface wave data.

The light beam optics, light collector, and wave measurement module may be described as measurement components and shown schematically in FIG. 4A as element 433.

The input 410 is configured to receive an input signal. The input signal may be an electrical signal encoding data. The input 410 is configured to provide that input signal to a stimulator which provides a stimulus to liquid 30 held in the reservoir 420. The stimulus provided by the input 410 generates a response 50 in the liquid 30. The response 50 may be one or more mechanical waves in and/or on the liquid, such mechanical waves may comprise a variety of wave modes including for example Lucassen waves.

The stimulator 431 of the spectroscopic ellipsometry apparatus 430 is configured to provide the stimulus to liquid 30 held in the reservoir 420. The stimulator may be any stimulator described herein.

The stimulator may be configured to provide an electrical stimulus to the liquid. The stimulator may comprise a pair of electrodes and a voltage provider wherein the voltage provider is configured to provide a voltage between the electrodes (e.g. an alternating voltage). The electrodes may be arranged to provide a voltage difference in a direction parallel to the surface of the liquid (e.g. the stimulator may comprise an interdigitated transducer, IDT) or perpendicular to (e.g. through) the surface of the liquid.

The reservoir 420 holds the liquid 30. The liquid 30 is configured to receive a stimulus (i.e. from the stimulator 431) based on an input signal from the input 410. A stimulus applied to the liquid generates a response 50 in the form of mechanical waves as described above. Optionally a thin film may be provided on the surface of the liquid.

The spectroscopic ellipsometry apparatus 430 is configured to measure the response 50 of the liquid 30 held in the reservoir 420 to the stimulus based on the input signal. In particular, measurement components 433 (i.e. the light beam optics, the light collector and the wave measurement module of the spectroscopic ellipsometry apparatus 430) are used to measure the response 50 and to provide the surface wave data as described above.

The output 440 is configured to provide an output signal based on the surface wave data (i.e. measured by the measurement components 433). The output signal depends on the input signal in a non-linear way and a function associated with transforming the input signal to the output signal corresponds to or represents a data operation wherein said data operation is performed by the operation of the reservoir computing unit on the input signal.

The reservoir computing unit 400 is configured to provide a transformation of the input signal into the output signal. The transformation may depend on any of: the characteristics of the liquid 30 in the reservoir (e.g. a liquid comprising a thin film); the thermodynamic parameters of the liquid and/or the thin film (e.g. temperature of the liquid); a specific depth of the liquid. The reservoir computing unit may be arranged such that the transformation performed by the unit can be controlled by varying one or more of such parameters.

In operation an input signal is provided to the input 410. The input signal encodes data or information e.g. in the form of a time-varying waveform. The stimulator 431 provides a stimulus to the liquid 30 indicative of the input signal from the input 410.

The stimulus induces a response 50 in the liquid 30. As set out above, the response 50 may be one or more mechanical waves. The response 50 is based on the input signal and the configuration of the reservoir computing system 400. The response 50 is measured by the measurement components 433 of the spectroscopic ellipsometry apparatus 430 to obtain surface wave data in the manner described herein.

The output 440 provides an output signal indicative of the surface wave data.

FIG. 4B is a simplified top-down schematic view of a reservoir computing unit 401 having two inputs 411 412. The reservoir computing unit 401 differs from the reservoir computing unit of FIG. 4A in that the unit 401 has two inputs, namely a first input 411 connected to a first stimulator 431 and a second input 412 connected to a second stimulator 432. The unit 401 can be used to provide two stimuli based on the respective input signals to a liquid to thereby generate a response in the liquid. The response will be based on both input signals and therefore, the output signal which is based on the response will be based on both input signals. By applying two stimuli the two inputs may be combined by the unit.

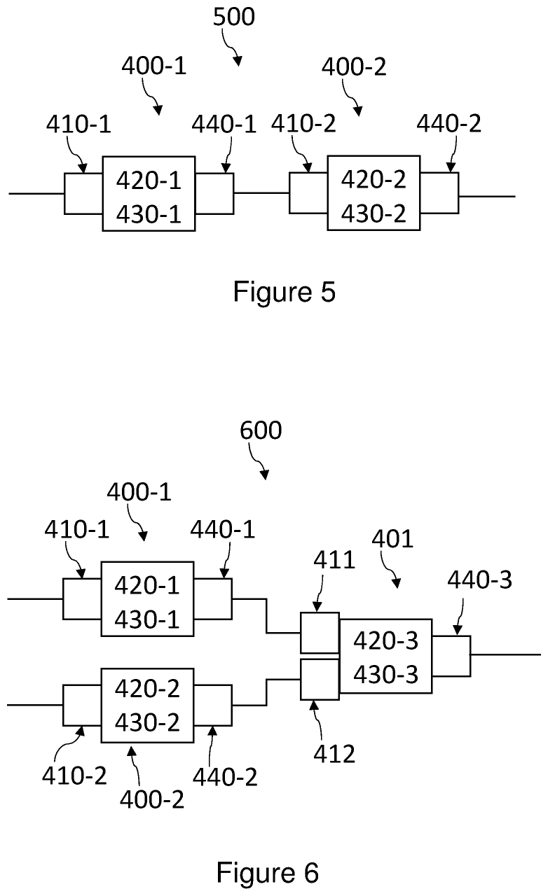

FIG. 5 is a schematic view of a first reservoir computing system 500 comprising a plurality of reservoir computing units. In this example, a first unit 400-1 coupled in series with a second unit 400-2 i.e. the output 440-1 of the first unit 400-1 is connected to the input 410-2 of the second unit 400-2.

Both, the first reservoir computing unit 400-1 shown in FIG. 5 and the second reservoir computing unit 400-2 shown in FIG. 5 may be provided by the reservoir computing units such as those described above with reference to FIG. 4A.

FIG. 5 shows reservoir computing units arranged in series to perform a series of transformations on an initial input signal (i.e. the input signal provided to a reservoir computing unit which is first in said series) to provide a final output signal (i.e. the output signal provided by a reservoir computing unit which is the final unit in said series) which is the result of the series of operations on the initial input signal.

FIG. 6 is a schematic view of a second reservoir computing system 600 comprising a plurality of reservoir computing units 400-1, 400-2, 401.

Both, the first reservoir computing unit 400-1 shown in FIG. 6 and the second reservoir computing unit 400-2 shown in FIG. 6 may be provided by the reservoir computing units such as those described above with reference to FIG. 4A. The third reservoir computing unit 401 shown in FIG. 6 may be provided by the reservoir computing unit such as that described above with reference to FIG. 4B.

FIG. 6 shows the first and second reservoir computing units 400-1 and 400-2 arranged in parallel to provide respective inputs to a third reservoir computing unit 401. A layered network is provided by connecting the first output 440-1 of the first reservoir computing unit 400-1 to a first input 411 of a third reservoir computing unit 401 and by connecting a second output 440-2 of the second reservoir computing unit 400-2 to a second input 412 of the third reservoir computing unit 401. In this way, two parallel transformations are applied to respective inputs by the first and second units 400-1 & 400-2 then provided as inputs to a third reservoir computing unit 401 to provide an output 440-3 based on two separate inputs and three transformations (i.e. one transformation from each unit).

It will be appreciated that a layered network may be provided by arranging any number of reservoir computing units in the manners depicted in FIG. 5 and FIG. 6.

The stimulator has been described as applying an electrical stimulus but other types of stimulus can be used, for example, the stimulator may be configured to provide a mechanical stimulus to the surface. For example, the stimulator may comprise an electromechanical element such as a piezoelectric transducer. The stimulator may be configured to provide a chemical stimulus to the surface. The mechanical and/or chemical stimulus may be provided in addition or as an alternative to the electrical stimuli described herein.

In examples wherein a reservoir computing system is provided each reservoir computing unit in said system may: have the same liquid in their respective reservoirs; or, at least one reservoir has a liquid in its respective reservoir which is different from the liquid in the other reservoirs; or, each reservoir has a unique liquid in its respective reservoir.

Liquids with thin films are described herein but embodiments of the present disclosure do not need a thin film. Instead embodiments may have a simple liquid provided in a reservoir and a stimulus can be applied on the surface of a simple liquid.

The wave measurement module may be coupled to the detector to
light beam optics for illuminating an area of the liquid thin film with a light beam, the light beam having a first polarisation, and
a light collector coupled to a detector for receiving the light beam after reflection by the liquid thin film, the light beam having a second polarisation after reflection by the liquid thin film;

Wave measurement modules described herein may be coupled to the light collector and/or the detector which is coupled to the light collector, thereby to provide surface wave data to characterise a Lucassen wave in the liquid thin film based on the second polarisation.

Where ranges are recited herein these are to be understood as disclosures of the limits of said range and any intermediate values between the two limits.

With reference to the drawings in general, it will be appreciated that schematic functional block diagrams are used to indicate functionality of systems and apparatus described herein. It will be appreciated however that the functionality need not be divided in this way, and should not be taken to imply any particular structure of hardware other than that described and claimed below. The function of one or more of the elements shown in the drawings may be further subdivided, and/or distributed throughout apparatus of the disclosure. In some embodiments the function of one or more elements shown in the drawings may be integrated into a single functional unit.

In some examples the functionality of the controllers and processing means described herein (such as the wave measurement module) may be provided by mixed analogue and/or digital processing and/or control functionality. It may comprise a general purpose processor, which may be configured to perform a method according to any one of those described herein. In some examples the controller may comprise digital logic, such as field programmable gate arrays, FPGA, application specific integrated circuits, ASIC, a digital signal processor, DSP, or by any other appropriate hardware. In some examples, one or more memory elements can store data and/or program instructions used to implement the operations described herein. Embodiments of the disclosure provide computer program products such as tangible, non-transitory storage media comprising program instructions operable to program a processor to perform any one or more of the methods described and/or claimed herein and/or to provide data processing apparatus as described and/or claimed herein. Such a controller may comprise an analogue control circuit which provides at least a part of this control functionality. An embodiment provides an analogue control circuit configured to perform any one or more of the methods described herein.

The above embodiments are to be understood as illustrative examples. Further embodiments are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims. These claims are to be interpreted with due regard for equivalents.

1. A spectroscopic ellipsometry apparatus for characterising an interaction between a stimulus and a liquid thin film, the apparatus comprising:
a stimulator, configured to provide a stimulus to a liquid thin film disposed on a volume of liquid to generate a wave in the liquid thin film, the liquid thin film and the volume of liquid having an interface therebetween,
light beam optics for illuminating an area of the liquid thin film with a light beam, the light beam having a first polarisation, and
a light collector coupled to a detector for receiving the light beam after reflection by the liquid thin film, the light beam having a second polarisation after reflection by the liquid thin film;
a wave measurement module coupled to the light collector and configured to provide surface wave data to characterise a Lucassen wave in the liquid thin film based on the second polarisation.

2. A spectroscopic ellipsometry apparatus configured to provide a reservoir computing unit for use in a reservoir computing system, the apparatus comprising:
a stimulator, configured to provide a stimulus to a liquid to generate a wave at the surface of the liquid,
light beam optics for illuminating an area of the liquid thin film with a light beam, the light beam having a first polarisation, and
a light collector coupled to a detector for receiving the light beam after reflection by the surface, the light beam having a second polarisation after reflection by the wave;
a wave measurement module coupled to the light collector and configured to provide surface wave data based on the second polarisation;
an output for providing an output signal based on the surface wave data.

3. The apparatus of claim 2 wherein the surface of the liquid carries a liquid thin film, the liquid thin film and the liquid having an interface therebetween.

4. The apparatus of claim 2 or 3 wherein the stimulator is configured to provide the stimulus based on an output signal provided from another reservoir computing unit.

5. The apparatus of any of claims 2 to 4 wherein the apparatus is configured such that effects of Lucassen waves are determinable from the surface wave data.

6. The apparatus of any preceding claim wherein the surface wave data is based on:
an s-polarisation component of the second polarisation and on
a p-polarisation component of the second polarisation.

7. The apparatus of any preceding claim wherein the surface wave data comprises a first time series of samples, for example wherein the samples are collected from the liquid thin film.

8. The apparatus of claim 7 wherein the wave measurement module is configured to provide, based on the first time series, a second time series wherein the second time series has a lower sample rate than the first time series.

9. The apparatus of claim 8 wherein the second time series has a sample rate of at least 2 kHz, for example at least 10 kHz.

10. The apparatus of claim 9 wherein the second sample rate is selected based on the size of the area.

11. The apparatus of any preceding claim wherein the light beam comprises a beam of coherent light, such as a laser.

12. The apparatus of any preceding claim wherein the light beam optics focus the beam of light.

13. The apparatus of claim 12 wherein a focal point of the beam is positioned so that the beam is diverging when it meets the light collector.

14. The apparatus of any preceding claim dependent upon claim 1 or claim 3 wherein the liquid thin film comprises at least one of a protein and a lipid.

15. The apparatus of claim 14 wherein the light beam comprises wavelengths selected according to a component of the thin film.

16. The apparatus of any preceding claim dependent upon claim 1 or claim 3 wherein the light beam is provided to the surface at an angle of incidence selected according to a component of the thin film.

17. The apparatus of any preceding claim wherein the stimulator comprises a test substance provider configured to contact the surface of the liquid with a test substance thereby to provide the stimulus.

18. The apparatus of any preceding claim wherein the stimulator is configured to provide an electrical stimulus to the surface of the liquid, for example to the thin film.

19. The apparatus of any preceding claim wherein operation of the light collector is coupled to operation of the stimulator such that surface wave data can be determined at selected times after the stimulus, for example wherein the said times are selected based on a location of the stimulus on the surface.

20. The apparatus of any preceding claim wherein the stimulator generates a plurality of wave modes, such as surface wave modes, for example in the liquid thin film.

21. The apparatus of claim 20 wherein the plurality of wave modes comprise, in addition to Lucassen waves, at least one of capillary waves, gravity waves and Rayleigh waves.

22. A method comprising:
providing a stimulus to a surface of a liquid to generate a wave at the surface,
illuminating an area of the liquid with a light beam, the light beam having a first polarisation, and
receiving the light beam after reflection by the wave, the light beam having a second polarisation after reflection by the wave;
determining, based on the received light beam, surface wave data based on the second polarisation; and
providing an output signal based on the surface wave data.

23. The method of claim 22 wherein the surface of the liquid carries a liquid thin film, the liquid thin film and the liquid having an interface therebetween.

24. The method of claim 23 wherein the surface wave data is capable of characterising a Lucassen wave in the liquid thin film based on the second polarisation.

25. The method of any of claims 22 to 24 wherein the stimulus is based on an output signal provided from a reservoir computing unit.

26. The method of any of claims 22 to 25 wherein the surface wave data is based on: an s-polarisation component of the second polarisation and on a p-polarisation component of the second polarisation.

27. The method of claims 22 to 26 wherein the size of the area is defined by the beam size at the surface and has a radius of less than 1 mm.

28. The method of claim 27 comprising focusing the beam of light to provide the beam size and so that the beam is diverging when it meets the light collector.

29. A reservoir computing unit comprising:
an input for receiving an input signal,
a reservoir for holding a liquid,
a spectroscopic ellipsometry apparatus configured to measure the response of a liquid held in the reservoir to a stimulus based on the input signal, and
an output for providing an output signal based on the measured response.

30. The reservoir computing unit of claim 29 wherein the spectroscopic ellipsometry apparatus comprises the spectroscopic ellipsometry apparatus of any of claims 1 or 6 to 21 as dependent upon claim 1.

31. A reservoir computing system comprising at least one reservoir computing unit according to claim 29 or 30 or at least one reservoir computing unit provided by the apparatus of any of claims 2 to 22 as dependent upon claim 2.

32. The reservoir computing system of claim 31 comprising a plurality of said computing units coupled together wherein the stimulator of the at least one of said computing units is provided based on the output from at least one other of the plurality of units.
